(19) United States
(12) Patent Application Publication
(10) Pub. No.: US 2019/0346687 A1
(43) Pub. Date: Nov. 14, 2019

(54) INTEGRATED STRUCTURE OF FLOOD ILLUMINATOR AND DOT PROJECTOR

(71) Applicant: Sray-Tech LTD., Taipei City (TW)

(72) Inventor: Xun-Yu Zheng, Keelung City (TW)

(21) Appl. No.: 16/003,079

(22) Filed: Jun. 7, 2018

(30) Foreign Application Priority Data
May 10, 2018 (TW) 107115877

(51) Int. Cl. G02B 27/42; G02B 27/30; G02B 26/08; G02B 5/02

(52) U.S. Cl. CPC G02B 27/425; G02B 27/30; G06T 7/521; G02B 26/0875; G02B 5/0294; G02B 26/0808

(57) ABSTRACT

The present invention provides an integrated structure of a flood illuminator and a dot projector, the structure includes a light source emitter, a collimator disposed at a front side of the light source emitter, an integrated lens located at the front side of the light source emitter, the integrated lens includes a diffractive optical element (DOE) and a diffuser, and a switching device connected to the integrated lens, to control the DOE or the diffuser of the integrated lens aligned with the position of the light source emitter.

### BACKGROUND OF THE INVENTION

### 1. Field of the Invention

The invention relates to the field of optics, and in particular to an integrated structure of a floodlight illuminator and a dot projector.

### 2. Description of the Prior Art

With the advancement of science and technology, mobile phones have become one of the indispensable personal belongings of people. Therefore, the protection technology for personal mobile phone data has also been continuously researched and developed.

In recent years, with the development of 3D stereoscopic image sensing technology, electronic products with face recognition functions have gradually appeared on the market. Taking a mobile phone as an example, the mobile phones with face recognition function includes at least a flood illuminator, a dot projector and an infrared camera. The face recognition process of a mobile phone includes three steps in sequence: proximity sensing (determining whether an object approaches a mobile phone), flood illuminating sensing, and dot projecting sensing. It is worth noting that the method of sensing by the flood illuminator includes emitting a light source (e.g., infrared light) with a larger irradiation angle by the flood illuminator and projecting onto the surface of an object (e.g., a human face). Afterwards, the infrared light reflected from the object is received by the infrared camera, and then calculating by a processor or the like, roughly determines whether the object is a human face. When the object is determined to be a human face, the dot projector emits a plurality of light spots (for example, more than thousands or tens of thousands) projected onto the human face, and an infrared camera is used to receive the changing of the reflected light spot, to calculate the virtual face surface profile. It is used to accurately determine whether the detected face is the user of the mobile phone or other authenticated person.

However, the flood illuminator and the dot projector are two different components, but also include a light source emitter. Therefore, if the flood illuminator and the dot projector can be integrated, the production cost of the mobile phone can be reduced and the hardware accommodation space of the mobile phone can be increased.

### SUMMARY OF THE INVENTION

The present invention provides an integrated structure of a flood illuminator and a dot projector, the structure includes alight source emitter, a collimator disposed at a front side of the light source emitter, an integrated lens located at the front side of the light source emitter, the integrated lens includes a diffractive optical element (DOE) and a diffuser, and a switching device connected to the integrated lens, to control the DOE or the diffuser of the integrated lens aligned with the position of the light source emitter.

Since the flood illuminator and the dot projector have partially similar functions, for example, both include a light source emitter and a collimator, and during the face recognition of the mobile phone, the flood illuminator and the dot projector will not be used at the same time. Therefore, the present invention is characterized in that integrating the flood illuminator and the dot projector into a structure, and the mode of the integrated structure is changed by the switching device. In this way, one single structure can be used as a flood illuminator or a dot projector respectively, to replace the two different components of the original flood illuminator and the dot projector, thereby reducing the production cost of the mobile phone and increasing hardware accommodation space for mobile phones.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic cross-sectional view diagram illustrating an integrated structure of a flood illuminator and a dot projector of the present invention.

FIG. 2 is a schematic top view diagram illustrating an integrated structure of the flood illuminator and the dot projector of the present invention in a flood illuminator mode.

FIG. 3 is a schematic top view diagram illustrating an integrated structure of the flood illuminator and the dot projector of the present invention in a dot projector mode.

### DETAILED DESCRIPTION

To provide a better understanding of the present invention to users skilled in the technology of the present invention, preferred embodiments are detailed as follows. The preferred embodiments of the present invention are illustrated in the accompanying drawings with numbered elements to clarify the contents and effects to be achieved.

Please note that the figures are only for illustration and the figures may not be to scale. The scale may be further modified according to different design considerations. When referring to the words “up” or “down” that describe the relationship between components in the text, it is well known in the art and should be clearly understood that these words refer to relative positions that can be inverted to obtain a similar structure, and these structures should therefore not be precluded from the scope of the claims in the present invention.

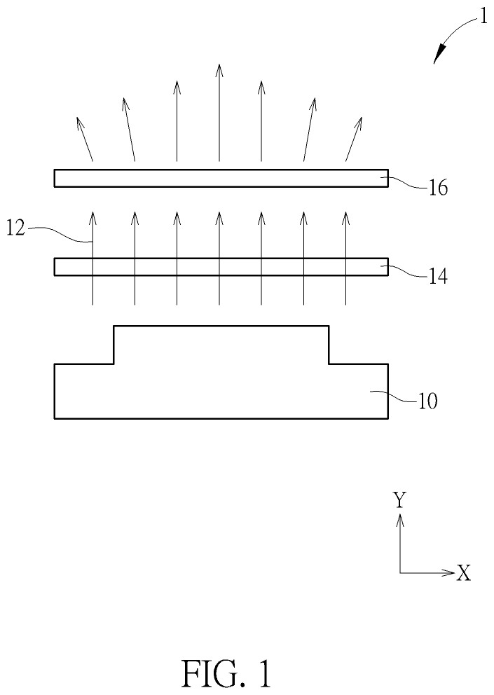

Please refer to FIG. 1, which is a schematic cross-sectional view diagram of an integrated structure of a flood illuminator and a dot projector of the present invention. As shown in FIG. 1, the integrated structure 1 of the present invention includes a light source emitter 10. Here, the direction of the light source (for example, visible light, infrared ray, etc.) emitted by the light source emitter 10 is defined as a front side (for example, the +Y direction in FIG. 1). A light source 12 is emitted toward the front side of the light source emitter 10, and a collimator 14 and an integrated lens 16 are disposed along the front side of the light source 12. In other words, when the light source 12 is emitted by the light source emitter 10, it will pass through the collimator 14 and the integrated lens 16 in sequence. The light source 12 is preferably laser light, but it is not limited thereto. The main function of the collimator 14 is to converge the lights emitted in different directions into parallel lights, and the function of the composite lens 16 will be described in the following paragraphs.

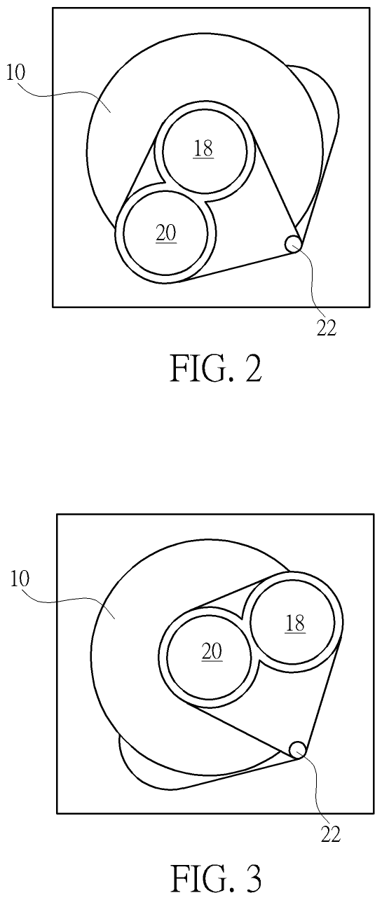

Regarding the integrated lens 16, please refer to FIG. 2 and FIG. 3. FIG. 2 is a schematic top view diagram illustrating an integrated structure of the flood illuminator and the dot projector of the present invention in a flood illuminator mode, and FIG. 3 is a schematic top view diagram illustrating an integrated structure of the flood illuminator and the dot projector of the present invention in a dot projector mode. As shown in FIG. 2, the integrated lens 16 includes a diffuser 18 and a diffractive optical element (DOE) 20. In this embodiment, the diffuser 18 and the diffractive optical element 20 are located in a same plane, and the integrated lens 16 is connected to a switching device 22, and the switching device 22 can be turned on or be turned off to switch the integrated lens 16 along the plane. The diffuser 18 or the diffractive optical element 20 is aligned with the light source emitter 10 along an emitting direction of the light source emitter 10 (the passing path of the light source 12).

In more detail, taking the present embodiment as an example, in a default state, the diffuser 18 of the integrated lens 16 is aligned with the passing path of the light source 12, that is, in the default state, after the light source 12 passes through the collimator 14, it will pass through the diffuser 18 and will not pass through the diffractive optical element 20. The integrated lens 16 includes a switching device 22, the switching device 22 is a control module such as various electronically controlled switches and processors connected to a mobile phone. For example, a signal from a processor in the mobile phone can control the switching device 22 to change the position of the integrated lens 16. As shown in FIG. 3, when a current is applied to the switching device 22, the position of the integrated lens 16 is also changed. At this time, the diffractive optical element 20 will be aligned with the emitting direction of the light source 12 of the light source emitter 10. In other words, after the light source 12 passes through the collimator 14, it will pass through the diffractive optical element 20, and at this time, the diffuser 18 of the integrated lens 16 will no longer disposed along the path of the light source 12. According to the applicant's experimental results, the power required to activate the switching device 22 is extremely small, approximately less than 60 milliamperes (mA). In addition, the switching device 22 further includes an automatic return device (not shown), such as a magnetic suction device or a spring device. After the power supply to the switching device 22 is stopped, the automatic return device will help the integrated lens 16 returns to the default position (e.g., the position shown in FIG. 2) and does not require extra power consumption.

In the present invention, the integrated structure 1 includes a flood illuminator mode and a dot projector mode. In more detail, when the integrated structure 1 is in the flood illuminator mode (the state shown in FIG. 2), it has the function of a flood illuminator. On the other hand, when it in the dot projector mode (the state shown in FIG. 3), it has the function of a dot projector. In practical applications, taking the present embodiment as an example, when the proximity sensor (not shown in the figure) of the mobile phone detects an object approaching, the integrated structure 1 starts the flood illuminator mode, as shown in FIG. 2. In the default state, when the parallel laser light (i.e., the light source 12 after passing through the collimator 14) passes through the diffuser mirror 18, the light source 12 will diverge in different directions. In other words, when the light source 12 of the light source emitter 10 passes through the diffuser mirror 18, it will produce a light source with a large area of illumination angle. The combined structure of the light emitter 10, the collimator 14 and the diffuser 18 can be used as a flood illuminator. After detecting the object closing to the mobile phone is a human face, the integrated structure 1 will then start the dot projector mode. As shown in FIG. 3, the switching device 22 is activated to change the position of the integrated lens 16, so that the diffractive optical element 20 is aligned with the emitting direction of the light source 12 of the light source emitter 10, when parallel laser light (i.e., the light source 12 after passing through the collimator 14) passes through the diffractive optical element 20, a plurality of (for example, thousands or tens of thousands) light spots will be generated. In other words, the combined structure of the light source emitter 10, the collimator 14, and the diffractive optical element 20 can be regarded as a dot projector. In the subsequent steps, the light spots are projected onto the human face and are reflected, and the virtual human face profile can be calculated by receiving the reflected light spot changing with the infrared camera, and compared with the authenticated face information.

Since the flood illuminator and the dot projector have partially similar functions, for example, both include a light source emitter and a collimator, and during the face recognition of the mobile phone, the flood illuminator and the dot projector will not be used at the same time. Therefore, the present invention is characterized in that integrating the flood illuminator and the dot projector into a structure, and the mode of the integrated structure is changed by the switching device. In this way, one single structure can be used as a flood illuminator or a dot projector respectively, to replace the two different components of the original flood illuminator and the dot projector, thereby reducing the production cost of the mobile phone and increasing hardware accommodation space for mobile phones.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An integrated structure of a flood illuminator and a dot projector, comprising:
a light source emitter;
a collimator disposed at a front side of the light source emitter;
an integrated lens located at the front side of the light source emitter, the integrated lens comprises a diffractive optical element (DOE) and a diffuser; and
a switching device connected to the integrated lens, to control the DOE or the diffuser of the integrated lens aligned with the position of the light source emitter.

2. The integrated structure of the flood illuminator and a dot projector of claim 1, wherein the diffractive optical element and the diffuser of the integrated lens are located in a same plane.

3. The integrated structure of the flood illuminator and a dot projector of claim 1, further comprising a control module connected to the switching device.

4. The integrated structure of the flood illuminator and a dot projector of claim 1, wherein the integrated structure of the flood illuminator and a dot projector includes a flood illuminator mode and a dot projector mode.

5. The integrated structure of the flood illuminator and a dot projector of claim 4, wherein the integrated structure of the flood illuminator and a dot projector is in the dot projector mode while the diffractive optical element is aligned with the light source emitter along an emitting direction of the light source emitter.

6. The integrated structure of the flood illuminator and a dot projector of claim 4, wherein the integrated structure of the flood illuminator and a dot projector is in the flood illuminator mode while the diffuser is aligned with the light source emitter along an emitting direction of the light source emitter.

7. The integrated structure of the flood illuminator and a dot projector of claim 1, wherein the collimator is disposed between the light source emitter and the integrated lens.

8. The integrated structure of the flood illuminator and a dot projector of claim 1, wherein the light source emitter emits a laser light along the front side.

9. The integrated structure of the flood illuminator and a dot projector of claim 1, wherein the switching device comprises an automatic return device.
